(19) United States
(12) Patent Application Publication
(10) Pub. No.: US 2019/0019230 A1
(43) Pub. Date: Jan. 17, 2019

(54) SYSTEM AND METHOD FOR PRESENTING COMMUNITY EMOTIVE DATA GEOGRAPHICALLY ON A SOCIAL MAPPING NETWORK

(71) Applicant: YouMap, Inc., New York, NY (US)

(72) Inventor: Stephen Constantinides, New York, NY (US)

(21) Appl. No.: 16/035,380

(22) Filed: Jul. 13, 2018

Related U.S. Application Data
(60) Provisional application No. 62/532,007, filed on Jul. 13, 2017.
(60) Provisional application No. 62/531,859, filed on Jul. 12, 2017.

(51) Int. Cl. G06Q 30/02; H04W 4/18; H04L 29/08; H04L 12/58; G06F 17/30; G06F 3/0481

(52) U.S. Cl. CPC G06Q 30/0282; H04W 4/185; H04L 67/18; G06Q 50/01; G06F 17/30991; G06F 3/04817; H04L 51/046

(57) ABSTRACT

A system for receiving location information on a social network comprising: a computer processor; a memory; and a content engine executing on the computer processor and configured to: display a map comprising at least one location and at least one review, wherein the at least one review is associated with the at least one location and provides information about the at least one review, and wherein the at least one review is created by at least one user of the social network; and displaying the at least one review in response to an input selecting the at least one review, wherein the at least one review is displayed based on attributes associated with a display on which the at least one review is being displayed.

### CROSS-REFERENCE TO RELATED APPLICATIONS

This application claims the benefit of, and priority to, U.S. Provisional Patent Application No. 62/532,007, filed on Jul. 13, 2017, which is entitled “SYSTEM AND METHOD FOR PRESENTING COMMUNITY EMOTIVE DATA GEOGRAPHICALLY ON A SOCIAL MAPPING NETWORK” and is incorporated by reference herein in its entirety for all purposes. This application claims the benefit of, and priority to, U.S. Provisional Patent Application No. 62/531,859, filed on Jul. 17, 2017, which is entitled “SYSTEM AND METHOD FOR PRESENTING COMMUNITY EMOTIVE DATA GEOGRAPHICALLY ON A SOCIAL MAPPING NETWORK” and is incorporated by reference herein in its entirety for all purposes.

### BACKGROUND

Recent advancements in computing technology and Global Navigation Satellite Systems (GNSS) have led to a movement for creating Internet-connected devices associated with their locations. Less expensive hardware has contributed to a trend in which traditional devices that connected via telephony and the Internet (e.g., email) now include location sharing. This has also lead to significant technical challenges in the development of client software and services to fully utilize these devices' capabilities.

As the number and type of network-connected computing devices has increased, there has been a fragmentation of content availability and quality among the various platforms. While some platforms provide social networking with friends, they may not provide information on where a particular friend is located. Moreover, given the current state of social networks, it would be impossible for a user to learn more about non-friends (e.g., users they are not connected to), their locations, and their opinions about those locations.

Thus, there is a need in the art for devices and systems that allow users to connect with non-connections based at least in part on their locations, and in some cases their opinions on their respective locations. Problems described herein are difficult to solve, and require unobvious solutions—which is the main reason such a social network has not been created. Further, this disclosure does not describe an abstract invention. On the contrary, this invention has hundreds of thousands of lines of code built over years of development, customer analysis, and other planning. The inventions require the technological developments of today's portable devices including GNSS receivers and various networks, and would not have been possible even a few years ago.

The disclosures herein are not a small leap over the prior art, but rather a technological disruption in the social media space. A complete rethinking was required to produce solutions to the difficult problems presented herein.

### SUMMARY

Embodiments provide technical solutions to the aforementioned and other technical problems. In general, in one aspect, methods may relate to reviews about locations may be associated with a social network. A user of a first client device may transmit a request to a system. The request may be for a review associated with at least one location—possibly many. The user of the first client device may then receive the requested review associated with the location(s). This review may be provided by a second user using a second client device. Upon receiving a request for a review, a second user may review the at least one location, and may include text, images, video, etc. The review provided by the second user may include temporally relevant information. For example, the review may have been made within the last 5 minutes. Also, the second user may be a user of the social network, as well as the first user. Once a review is created by the second user, it may be displayed on the first user's device, and may be represented by a symbol overlaying a map. The first user may then select the symbol representing the review, and their device may then display the review, or at least a portion thereof. Depending on the size of the display of the first client device, only a portion of the review may be shown on the first client device.

In general, in one aspect, embodiments relate to a system for providing reviews to users of a social network. A first user may send a request for a review about a location to the system. A second user may receive that request, and respond in kind. The review provided by the second user may be associated with a particular time, such as that day. Once a review has been provided, it may be represented by a symbol, which may be displayed on a map (e.g., near the location that the review is about). Next, a first user may select the symbol representing the review, and at least a portion of the review may be shown to the first user, on their device, based on the size of a display on their device.

In general, in one aspect, embodiments relate to a non-transitory computer-readable storage medium including a set of instructions for providing content, the instructions configured to execute on at least one computer processor to enable the computer processor to: transmit a request to a system where the request is for a review associated with at least one location. The request may be received by a second device which may allow a user of the second device to respond to the request for the review by providing a review (which may be written by a user of the second device). Such a review may be associated with a time. Next, a display on a first client device may show a map with a symbol representing the review. This symbol may be displayed on a map, indicating the location of the place the review is about. After selecting the symbol representing the review, at least a portion of the review may be displayed on the device that requested the review, wherein the portion displayed is based on the size of the display of the device.

Other aspects of the invention will be apparent from the following description and the appended claims.

### BRIEF DESCRIPTION OF THE DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

Embodiments of the present invention are illustrated by way of example, and not by way of limitation, in the figures of the accompanying drawings and in which like reference numerals refer to similar elements.

FIG. 1 illustrates a schematic diagram of a system, in accordance with one or more embodiments of the invention.

FIGS. 2-4 illustrate exemplary depictions of systems described herein, in accordance with one or more embodiments of the invention.

FIGS. 5 and 6 illustrate flowcharts of exemplary processes, in accordance with one or more embodiments of the invention.

FIGS. 7 and 8 are block diagrams of exemplary computing systems, in accordance with one or more embodiments of the invention.

### DETAILED DESCRIPTION OF THE INVENTION

Reference will now be made in detail to the various embodiments of the present disclosure, examples of which are illustrated in the accompanying drawings.

While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

In general, embodiments of the invention provide for a global intelligence system allowing any user to consume posted information or share information including observations, human activities, emotions, and experiences. This information may be associated with a user and/or a location. Further, this information may be posted or consumed in a quick way such that users on the go can view on a mobile device to learn more about the environment around other users, including where other users are located and/or what the environment is like where the other users are located.

In various embodiments, all users can post, communicate with other users, relay information (e.g., share or repost), distribute, and/or respond to information in a free form way similar to feeds on typical social networks. Further, users have easy access to controls which allow them to request information regarding a particular location, including how other users' reviews about certain locations (whether connections or non-connections (e.g., a user with a first connection to another user on a social network as opposed to a user on a social network that is not a first connection), also referred to as friends or non-friends). A user's reviews about a certain location may be represented by text, emojis or other symbols, pictures, videos, etc. It should be understood that herein, references may be made to various types of reviews, which may include, but are not limited to: responses, text, images, video, emojis (e.g., symbols that may represent or connote an emotion), emoji bubbles (e.g., a round shape that may include an emoji), shapes, and other graphics. It should be appreciated that any review may connote an emotion, which may be explicitly inputted by a user, quantified based on attributes of a review (e.g., text, images, emojis, and/or colors of a review), etc. Further, in some embodiments, a heatmap may be generated based on user reviews about a certain location. For example, one or more locations associated with positive reviews, or reviews that have been upvoted, may be represented on a map by a certain color (e.g., red), and one or more locations associated with negative reviews, or reviews that have been downvoted, may be represented on map by a different color (e.g., green). Moreover, degrees of positivity and/or negativity of the review(s) may be represented by different colors.

In various embodiments, a user's reviews may be limited to a certain time period, such as within the previous hour, within the previous day, within the previous month, etc. This time period may be customizable. In some embodiments, a device may show reviews only after a threshold number of reviews have been posted within a certain time period (e.g., the system may only show reviews if there were 25 reviews about a location between 8:00 p.m. and 10:00 p.m. earlier in the evening). In one or more embodiments, if a review is associated with a time (e.g., previous hour, customizable time, threshold number of reviews within a certain time), then information included in the review may be referred to as temporally relevant information. For example, if a user requests a review about a location and receives a review in response to the request within a few minutes, the information in that response may be temporally relevant. Similarly, if a request for a review of a salsa club is sent on a Saturday night, then a review may include reviews from many Saturday nights, and would thus also be temporally relevant. In other words, reviews and information in those reviews related to a time, date, day of the week, year, etc., may be referred to as temporally relevant. Moreover, in one or more embodiments, a review may be made within a particular time period. A particular time period may be a time window customized by a user, a date, a day of the week, a recent time (e.g., within 5, 10, 30, or 60 minutes), or any other specified period of time.

In various embodiments, users may view a map and see multiple reviews about a particular location. As described above, these reviews may include text, emojis, symbols, images, and/or video. As such, a user may click on a location on a map on their smart phone and view reviews posted by other users including emojis, text, and/or video from a particular time period (e.g., within the last 10 minutes).

In various embodiments, a system may be configured to show a user's connections. For example, a user may filter reviews by who they are connected to and see what their connections think about a location (e.g., a particular night club in downtown).

In various embodiments, users may also request information about a location. For instance, the system may determine that a user's connection is at a location and provide that information to the user. The user may then request to call that person, send a text message, request a review, and/or request an image and/or video from their connection. In such a case, a user would be provided with a review (including various information) from their connection in near-real-time about a location. In some embodiments, a user may make a request for a review of a location, to anyone using the system. For instance, a user may make a post asking about the environment at a location that the user is thinking about going to. This way, the user may have more information to make an informed decision prior to leaving to go to the location. It should be understood that a location may be any type of physical location, event, etc. For instance, a location may be a house party at a particular address, a concert in a park, a bicycle race, the top of a ski lift on a mountain, a beach, etc. In some embodiments a location may be moving/traveling (e.g., a party bus, a marathon, a pub crawl). It should be understood that a location may be determined by a GNSS receiver regardless of whether the location is moving or stationary.

In some embodiments, a plurality of locations may be suggested to a user based on a variety of information, including, but not limited to: reviews made at similar times of a previous year, reviews made on similar days of the week, reviews made at similar times of a day, reviews made at a current time, a current location, a past location, a number of times a location has been visited by a user, a number of times a location has been visited by one or more of a user's connections, a proximity/distance to a location, a number of times a location had been visited by a particular set of a user's connections, review made by a particular connection, and/or reviews made by a connection. For example, two bars may be suggested to a user because the user is at a restaurant (or has been at a restaurant for a certain amount of time) within a mile of the two bars, in addition, the user may have a connection at each at one of the suggested bars. In some embodiments, the two bars may be predicted by a device based on past visits by the user to the two bars.

In some embodiments, a user's device may provide notifications. For example, a notification may be provided based on attributes including, but not limited to: a location, a time, a pattern of times, reviews made at similar times of a previous year, reviews made on similar days of the week, reviews made at similar times of a day, reviews made at a current time, a current location, a past location, a number of times a location has been visited by a user, a number of times a location has been visited by one or more of a user's connections, a proximity/distance to a location, a number of times a location had been visited by a particular set of a user's connections, review made by a particular connection, and/or reviews made by a connection. For example, a person could be notified about a salsa dancing club every Thursday. Such a notification could include, or provide links to, reviews of the salsa dancing club on Thursday night at 10:00 p.m. A notification may also include an image, a review, a review including/associated with an image, etc.

Information shown on a user's device may include reviews, maps, locations of connections and non-connections, a current zoom level, etc. In some embodiments described herein, a user's device may include a map and data associated with the map including a zoom level, a pan location, available screen space, a distance between one location and another, a distance between one location and an area shown on a screen, etc.

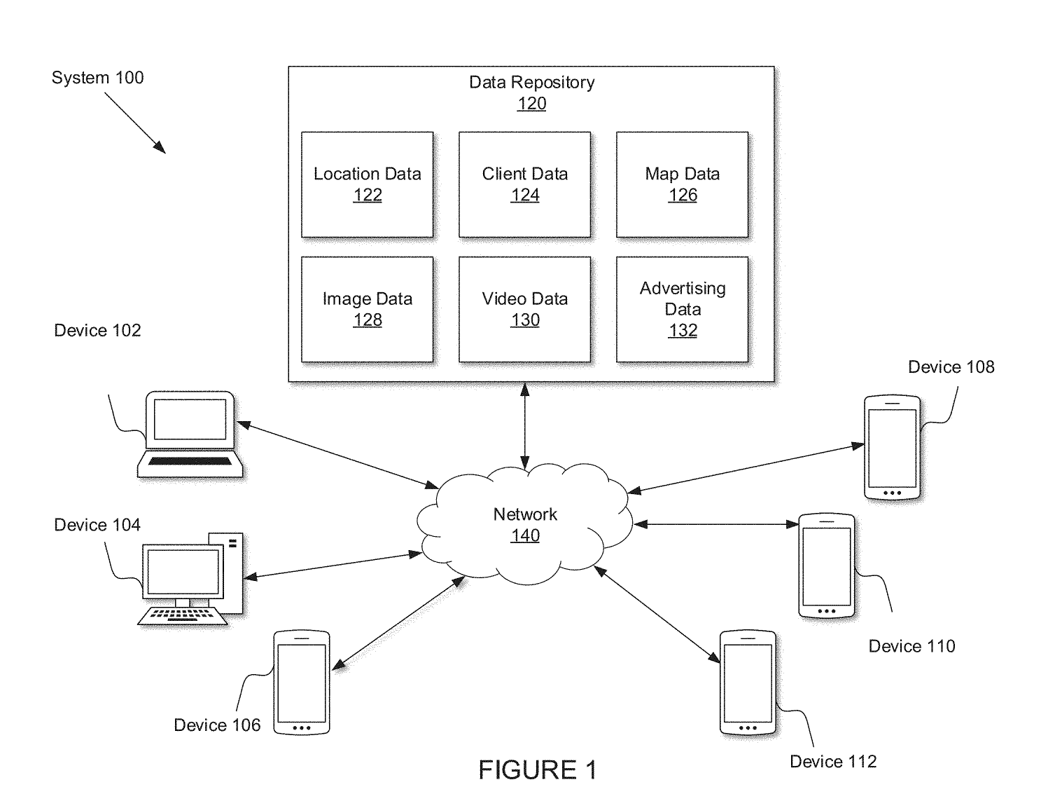

FIG. 1 illustrates an example schematic diagram of system 100, in accordance with one or more embodiments of the invention. System 100 may include devices 102, 104, 106, 108, 110, and 112 (e.g., electronic devices such as a computer, a smart phone, and/or a tablet). Devices 102, 104, and 106 may be devices belonging to a first user, which the first user may use to access system 100. Devices 108, 110, and 112 may be smart phones belonging to other users (e.g., not the first user, a connection, a non-connection). In some embodiments, devices 108, 110, and 112 may include a video camera at a location, an electronic assistant such as an Amazon Echo™, etc. Once a first user accesses system 100, the first user may be able to view a map of an area, locations, reviews of locations, locations of connections, locations of non-connections, etc. The various devices included in system 100 may be connected wirelessly via network 140.

FIG. 1 also includes example data repository 120. It should be understood that data repository 120 may include more, or less, data than shown in FIG. 1. Further, it should be understood that data repository 120 may be stored on a variety of devices such as a server, a multi-tenant environment (e.g., the cloud), etc.

Data repository 120 may include location data 122, client data 124, map data 126, image data 128, video data 130, and/or advertising data 132. Location data 122 may include data including, but not limited to: maps of various cities or areas, locations (also referred to as points of interest)—which may include night clubs and sporting events, the locations of connections, the locations of non-connections, and/or the location of a user.

Client data 124 may include information associated with clients, which may be defined as users or client devices, and include data such as, but not limited to: a current location of a client, previous locations of a client, and/or information about a client (e.g., music preference or activity preferences in the case of a user, or device type or operating system in the case of a client device).

Map data 126 may include information associated with a map, including, but not limited to: names of location, locations' coordinates, locations' addresses, data associated with transportation (e.g., directions, bus routes, available taxi services), connection information, and/or non-connection information.

Image data 128 may include image information which may include, but is not limited to: one or more images of the interior of one or more locations, one or more images of one or more users/connections/people/animals at one or more locations, one or more images of the area outside of one or more locations (e.g., a line outside of a night club), and/or one or more images not captured by a user (e.g., received by system 100 from the Internet).

Similarly, video data 130 may include, but is not limited to: one or more videos of the interior of one or more locations, one or more videos of one or more users/connections/people/animals at one or more locations, one or more videos of the area outside of one or more locations (e.g., a line outside of a night club), and/or one or more videos not captured by a user (e.g., received by system 100 from the Internet).

In some embodiments, data repository 120 may include advertising data 132, which may be shown on device 102, 104, 106, 108, 110, 112. This information may be shown on a map, or in some cases within a review to save screen real estate. The advertising data may include information including, but not limited to: a video, text, images, information associated with a location, information associated with a location where device 106, 108, 110, 112 is located or where it has previously been, and/or information associated with a location where a connection is located.

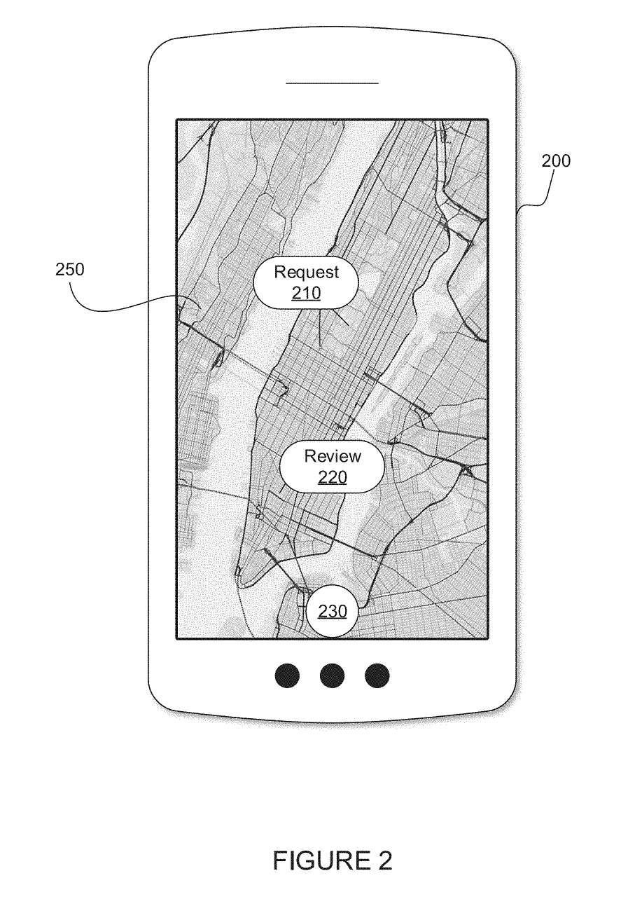

FIG. 2 illustrates an exemplary depiction of system 100 described herein, in accordance with one or more embodiments of the invention. Specifically, device 200 shown in FIG. 2 may be a smart phone or other device, such as devices 102, 104, 106, 108, 110, 112 shown in FIG. 1.

FIG. 2 may include map 250, which can show an area such as a country, state, city, or portion thereof. In some embodiments, a screen on device 200 may include multiple maps 250. For example, a screen may show a first map including an area and/or location where a first user is, and a second map including an area and/or location where another user is (e.g., a connection or non-connection) or an area where the user would like to see and/or go. For instance, one map might include a location where a user is located, and a second map might include a location with many reviews. In some embodiments, maps or sub-maps may be filtered by numbers of reviews, number of connections, etc.

FIG. 2 may include a control 230 which can manipulate a map, such as by changing an amount of zoom, changing the area shown by panning, etc. In addition, FIG. 2 may include a request 210 and/or a response 220. In some embodiments, a request may be a post or message from a user indicating that the user would like to know more about one or more locations. Such a request may be targeted toward one or more connections. In some embodiments, a request may be targeted to connections and non-connections at a particular location. For example, a request may be sent to anyone using system 100 that is at a location. Similarly, a request may be sent to anyone using system 100 that was at a location within a particular time period (e.g., the previous Saturday night, or within the last hour).

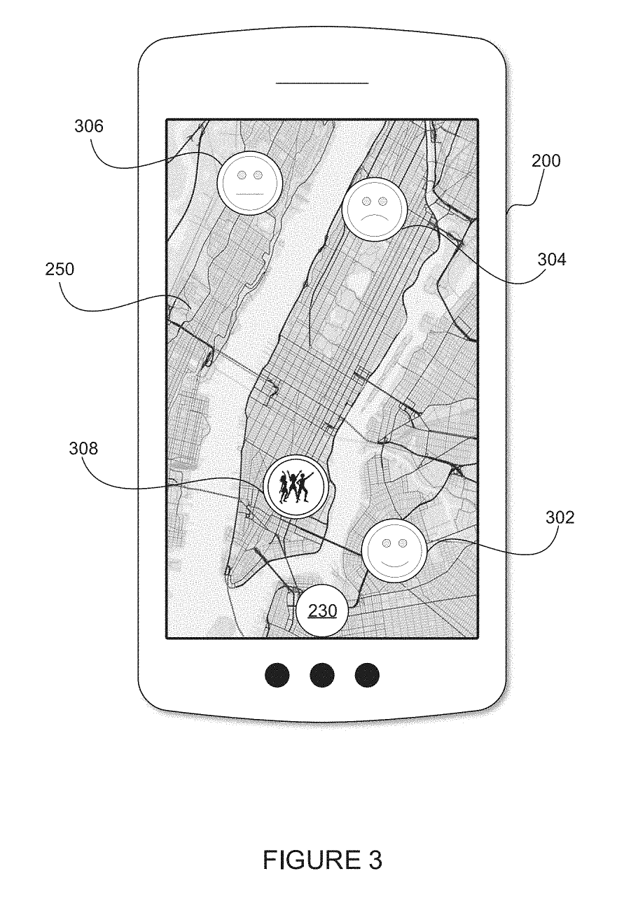

FIG. 3 illustrates an exemplary depiction of system 100 described herein, in accordance with one or more embodiments of the invention. Specifically, device 200 shown in FIG. 3 may be a smart phone or other device, such as that illustrated in FIG. 2. In addition, FIG. 3 illustrates reviews 302, 304, 306, 308. As described above, reviews may include location information, social and/or community data, bubbles, and/or emoji bubbles. For instance, the term review as used herein may include emoji bubbles.

In some embodiments, emoji bubbles may be colorful circles that represent or connote an emotion of a person at a location. These reviews 302, 304, 306, 308 (e.g., emoji bubbles) may communicate a specific action or emotion coupled with a tag/indicator of positive, negative, neutral, or unknown. For example, review 302 may indicate that a user is happy with a location, review 304 may indicate that a user is unhappy with a location, review 306 may indicate that a user is indifferent about a location, and review 308 may indicate that people are dancing at a location. Tags associated with emoji bubbles may change the appearance of emoji bubbles on a screen (e.g., from white to blue, red to gray, or any other shape or color based on an emotion).

In some embodiments, dozens, hundreds, or thousands of reviews 302, 304, 306, 308 may appear on a screen. In some embodiments, only a threshold amount of reviews 302, 304, 306, 308 may appear on a screen based on attributes of a device 200. For example, reviews may only be shown if a threshold number of reviews connoting similar emotions are included in a set of reviews (e.g., reviews may only be shown if at least 20 reviews associated with a location are created, and the emotions associated with those 20 reviews are happy and/or positive). The number of reviews shown on a screen may be based on the pixels on a screen, an amount of zoom on a map (e.g., the size of an area shown on a map), the distance between two locations (e.g., a user and a location), etc. When many reviews 302, 304, 306, 308 are difficult to represent, they may be reduced to small symbols such as circles indicating a location where a review 302, 304, 306, 308 was made, or a single review (e.g., a symbol) that represents many reviews.

In some embodiments, popular and/or relevant reviews 302, 304, 306, 308 (which may be in the form of emojis and/or represent emotion) may be expanded or enlarged based on factors including, but not limited to: how recently review 302, 304, 306, 308 was placed on a map and/or associated with a location, a relevant utility to users who have viewed review 302, 304, 306, 308, a number of reviews 302, 304, 306, 308 placed at a same location or close proximity that are similar in nature (e.g., express a similar sentiment and/or emotion), and shared comments directed toward a location. In some embodiments, a relevant utility to users may be determined by a number of positive or negative votes associated with one or more reviews 302, 304, 306, 308 by users. In addition, in some embodiments, shared comments may include review 302, 304, 306, 308 that is shared (e.g., reposted) by one or more users.

The factors described above may be quantified and referred to as a relevance number that represents the importance of various locations, which may be shown on map 250. These factors may include, but are not limited to: the factors listed above, a date and time that review 302, 304, 306, 308 was posted, a number of positive or negative upvotes or downvotes associated with review 302, 304, 306, 308, a number of comments associated with reviews 302, 304, 306, 308, and a date and time of comments associated with reviews 302, 304, 306, 308. In some embodiments, a larger relevance number may correspond to a larger relevance or higher importance.

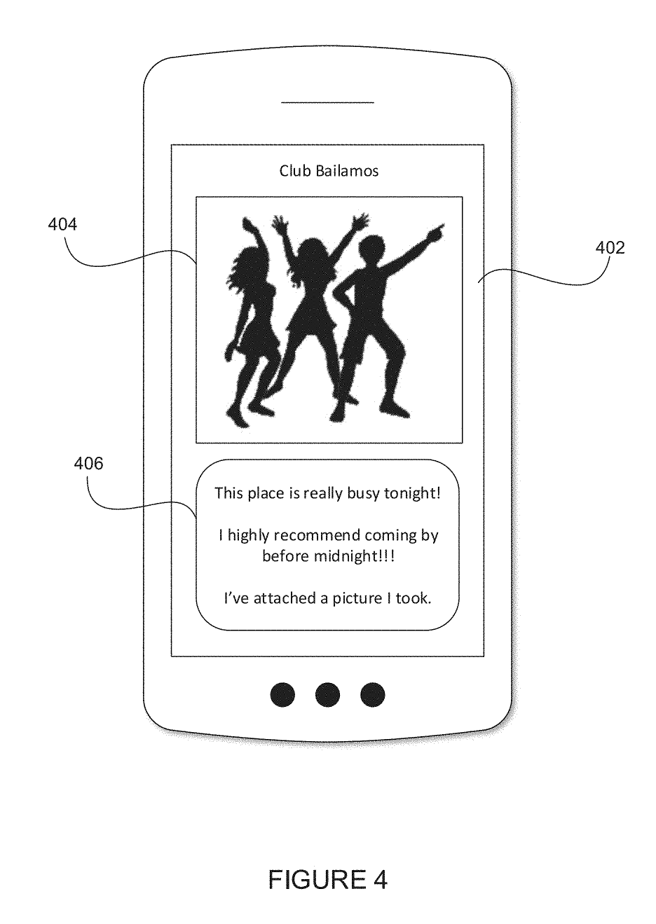

FIG. 4 illustrates an exemplary depiction of systems described herein, in accordance with one or more embodiments of the invention. FIG. 4 shows a review 402. Review 402 includes an image 404 and text 408. The review 402 may appear in response to device input such as the pressing of an emoji, in response to a request 210 for a review 220 (of FIG. 2), in response to typing in the name of a location, etc. In some embodiments users may view many reviews by swiping a screen, searching for a connection's reviews, searching for reviews within the previous 20 minutes, etc.

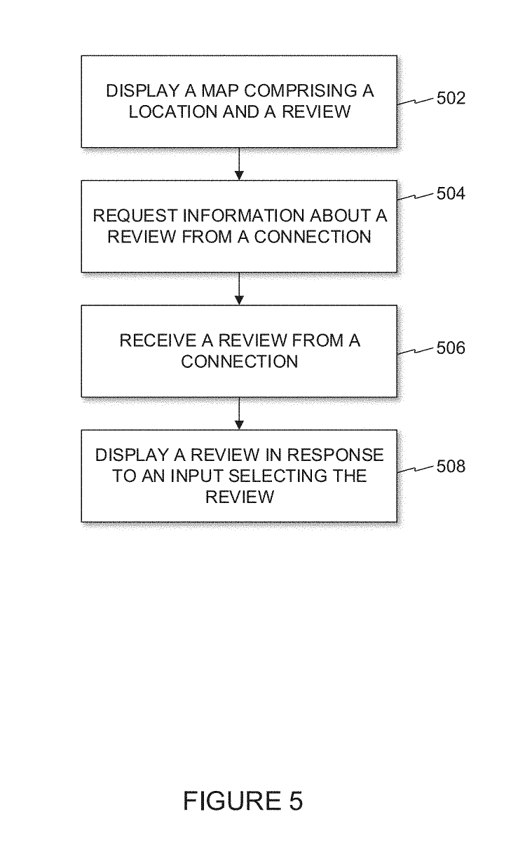

FIG. 5 shows a flowchart of a method for receiving location information on a social network, in accordance with one or more embodiments of the invention. While the various steps in the flowchart are presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 5 should not be construed as limiting the scope of the invention. In one or more embodiments, the steps of FIG. 5 can be performed by the cloud or a server (which may include data repository 120).

In STEP 502, in one or more embodiments of the invention, a map comprising a location and a review are displayed. In various embodiments, multiple reviews may be displayed, and one or more of those reviews may be associated with one or more locations. Reviews may be created by users of a social network, or reviews may be created by a system (e.g., system 100 of FIG. 1) by accessing canonical repository/database (e.g., Yelp™). In various embodiments, reviews may be in the form of emojis, emoticons, ideograms, ideographs, smileys, pictographs, emoji bubbles (e.g., a shape including/containing an emoji), symbols, text, images, videos, etc.

In STEP 504, in one or more embodiments of the invention, information about a review from a connection is requested. For instance, a user may request a review from a connection on the social network. In some embodiments, a user may request a review about a location, and a review may be created in response to the request by anyone (e.g., non-connections). In some embodiments, such reviews may only be created by users that are located at the location at the time of the request and/or creation of the review.

In STEP 506, in one or more embodiments of the invention, a review from a connection is received. As described above, a review may be received from a connection in response to a request from a user. In some embodiments, reviews may be upvoted and/or downvoted. In some embodiments, only reviews that have been upvoted may be delivered to a user. Similarly, in some embodiments, a review may only be received if it has a particular relevance number, which may be a quantified number based on factors such as when the review was posted, how recently the review was posted, how similar the review is to a user's interests, etc.

In STEP 508, a review is displayed in response to an input selecting the review. For example, a review may be displayed in response to a user clicking on a button indicating that a requested review has been received. In some embodiments, a review may be displayed in response to a user clicking on a review or location shown on a map. In some embodiments, where there are many reviews associated with a location, a user may click on the location and/or reviews, and the reviews may be shown as a list such that the user can view the various reviews. In some embodiments, a user may sort the reviews by users that posted the reviews, connection reviews, reviews with emojis, reviews with text, reviews with images, reviews with videos, reviews created within a particular time period, etc.

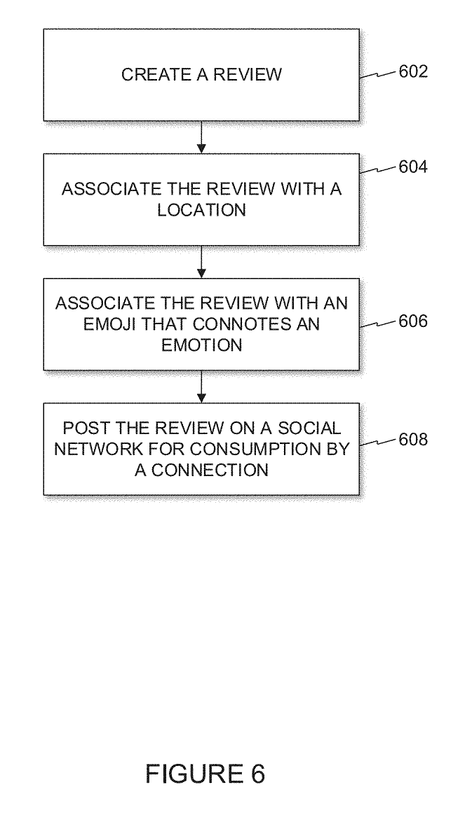

FIG. 6 shows a flowchart of a method for receiving location information on a social network, in accordance with one or more embodiments of the invention. While the various steps in the flowchart are presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 6 should not be construed as limiting the scope of the invention. In one or more embodiments, the steps of FIG. 6 can be performed by the cloud or a server (which may include data repository 120).

In STEP 602 a review is created. The review may be created by a user of the social network. In some embodiments, the review may be created in response to a request for a review. The request for the review may indicate what type of review the requestor would like. For example, the request may indicate that the requestor would like an emoji, text, images, and/or a video.

In STEP 604 a location is associated with a review. The location may be typed onto a device, or it may be selected from a map. In some embodiments where the review was requested, the location may already be determined and automatically associated with a review.

In STEP 606 a review is associated with an emoji that connotes an emotion. For example, a creator of a review may choose an emoji and/or a color to associate with a review based on how they feel about the location. In some embodiments, an emoji and/or a color associated with a review may be based on text included in the review. For example, if a review is created that includes the text “This place is great!” a happy-face emoji may be associated with the review.

In STEP 608 a review is posted on a social network for consumption by a connection. For example, after a user creates a review and associates the review with a location, any of the user's connections may view the review. In some embodiments, non-connections may also view the review.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

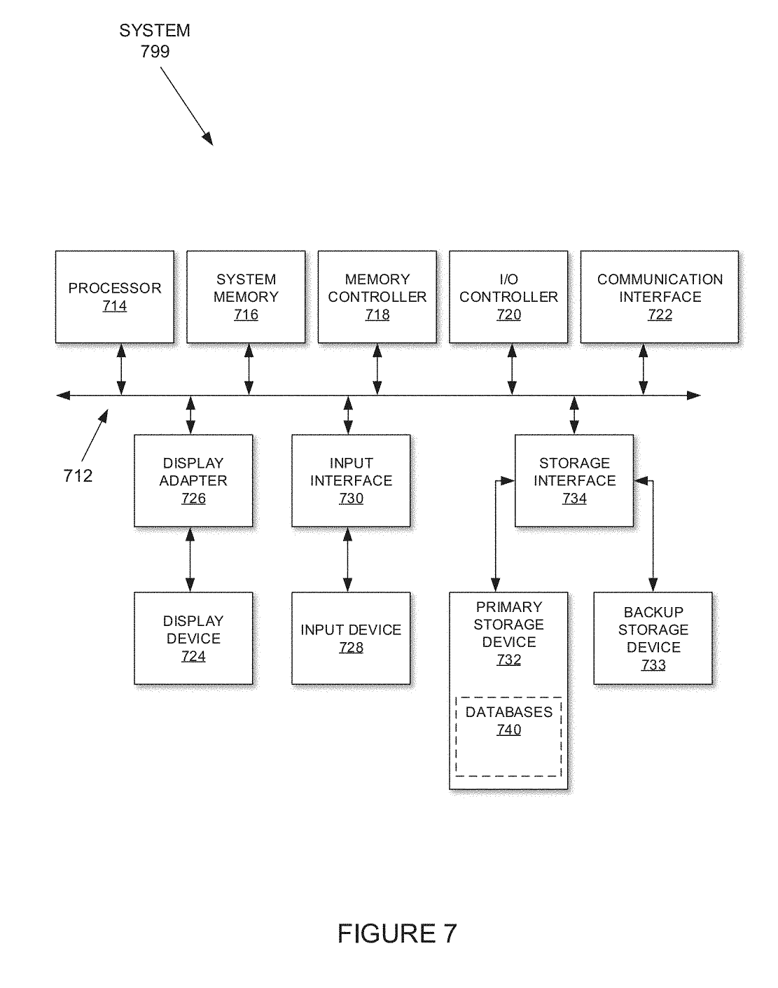

FIG. 7 is a block diagram of an example of a computing system 799 capable of implementing embodiments of the present disclosure. Computing system 799 broadly represents any single or multi-processor computing device or system capable of executing computer-readable instructions. Examples of computing system 799 include, without limitation, workstations, laptops, client-side terminals, servers, distributed computing systems, handheld devices, or any other computing system or device. In its most basic configuration, computing system 799 may include at least one processor 714 and a system memory 716.

Processor 714 generally represents any type or form of processing unit capable of processing data or interpreting and executing instructions. In certain embodiments, processor 714 may receive instructions from a software application or module. These instructions may cause processor 714 to perform the functions of one or more of the example embodiments described and/or illustrated herein.

System memory 716 generally represents any type or form of volatile or non-volatile storage device or medium capable of storing data and/or other computer-readable instructions. Examples of system memory 716 include, without limitation, RAM, ROM, flash memory, or any other suitable memory device. Although not required, in certain embodiments computing system 799 may include both a volatile memory unit (such as, for example, system memory 716) and a non-volatile storage device (such as, for example, primary storage device 732).

Computing system 799 may also include one or more components or elements in addition to processor 714 and system memory 716. For example, in the embodiment of FIG. 7, computing system 799 includes a memory controller 718, an input/output (I/O) controller 720, and a communication interface 722, each of which may be interconnected via a communication infrastructure 712. Communication infrastructure 712 generally represents any type or form of infrastructure capable of facilitating communication between one or more components of a computing device. Examples of communication infrastructure 712 include, without limitation, a communication bus (such as an Industry Standard Architecture (ISA), Peripheral Component Interconnect (PCI), PCI Express (PCIe), or similar bus) and a network.

Memory controller 718 generally represents any type or form of device capable of handling memory or data or controlling communication between one or more components of computing system 799. For example, memory controller 718 may control communication between processor 714, system memory 716, and I/O controller 720 via communication infrastructure 712.

I/O controller 720 generally represents any type or form of module capable of coordinating and/or controlling the input and output functions of a computing device. For example, I/O controller 720 may control or facilitate transfer of data between one or more elements of computing system 799, such as processor 714, system memory 716, communication interface 722, display adapter 726, input interface 730, and storage interface 734.

Communication interface 722 broadly represents any type or form of communication device or adapter capable of facilitating communication between example computing system 799 and one or more additional devices. For example, communication interface 722 may facilitate communication between computing system 799 and a private or public network including additional computing systems. Examples of communication interface 722 include, without limitation, a wired network interface (such as a network interface card), a wireless network interface (such as a wireless network interface card), a modem, and any other suitable interface. In one embodiment, communication interface 722 provides a direct connection to a remote server via a direct link to a network, such as the Internet. Communication interface 722 may also indirectly provide such a connection through any other suitable connection.

Communication interface 722 may also represent a host adapter configured to facilitate communication between computing system 799 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fiber Channel interface adapters, Ethernet adapters, or the like. Communication interface 722 may also allow computing system 799 to engage in distributed or remote computing. For example, communication interface 722 may receive instructions from a remote device or send instructions to a remote device for execution.

As illustrated in FIG. 7, computing system 799 may also include at least one display device 724 coupled to communication infrastructure 712 via a display adapter 726. Display device 724 generally represents any type or form of device capable of visually displaying information forwarded by display adapter 726. Similarly, display adapter 726 generally represents any type or form of device configured to forward graphics, text, and other data for display on display device 724.

As illustrated in FIG. 7, computing system 799 may also include at least one input device 728 coupled to communication infrastructure 712 via an input interface 730. Input device 728 generally represents any type or form of input device capable of providing input, either computer- or human-generated, to computing system 799. Examples of input device 728 include, without limitation, a keyboard, a pointing device, a speech recognition device, or any other input device.

As illustrated in FIG. 7, computing system 799 may also include a primary storage device 732 and a backup storage device 733 coupled to communication infrastructure 712 via a storage interface 734. Storage devices 732 and 733 generally represent any type or form of storage device or medium capable of storing data and/or other computer-readable instructions. For example, storage devices 732 and 733 may be a magnetic disk drive (e.g., a so-called hard drive), a floppy disk drive, a magnetic tape drive, an optical disk drive, a flash drive, or the like. Storage interface 734 generally represents any type or form of interface or device for transferring data between storage devices 732 and 733 and other components of computing system 799.

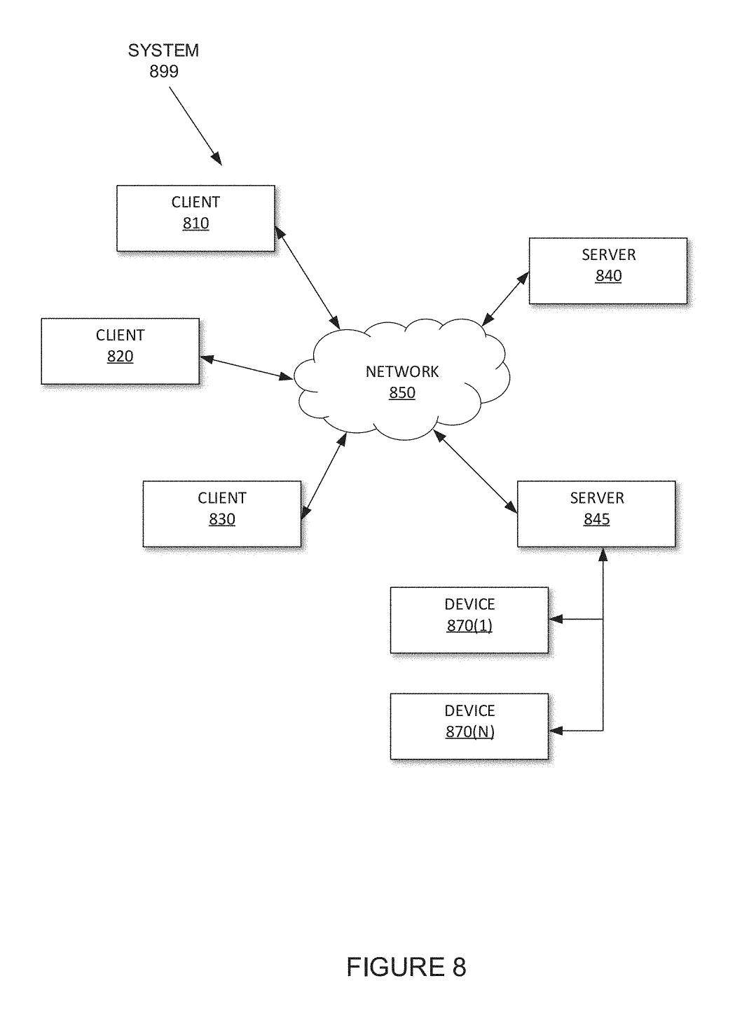

In one example, databases 740 may be stored in primary storage device 732. Databases 740 may represent portions of a single database or computing device or it may represent multiple databases or computing devices. For example, databases 740 may represent (be stored on) a portion of computing system 799 and/or portions of example network architecture 899 in FIG. 8 (below). Alternatively, databases 740 may represent (be stored on) one or more physically separate devices capable of being accessed by a computing device, such as computing system 799 and/or portions of network architecture 899.

Continuing with reference to FIG. 7, storage devices 732 and 733 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 733 may also include other similar structures or devices for allowing computer software, data, or other computer-readable instructions to be loaded into computing system 799. For example, storage devices 732 and 733 may be configured to read and write software, data, or other computer-readable information. Storage devices 732 and 733 may also be a part of computing system 799 or may be separate devices accessed through other interface systems.

Many other devices or subsystems may be connected to computing system 799. Conversely, all of the components and devices illustrated in FIG. 7 need not be present to practice the embodiments described herein. The devices and subsystems referenced above may also be interconnected in different ways from that shown in FIG. 7. Computing system 799 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 799. All or a portion of the computer program stored on the computer-readable medium may then be stored in system memory 716 and/or various portions of storage devices 732 and 733. When executed by processor 714, a computer program loaded into computing system 799 may cause processor 714 to perform and/or be a means for performing the functions of the example embodiments described and/or illustrated herein. Additionally or alternatively, the example embodiments described and/or illustrated herein may be implemented in firmware and/or hardware.

For example, a computer program for requesting advertising content for display by a thin client application may be stored on the computer-readable medium and then stored in system memory 716 and/or various portions of storage devices 732 and 733. When executed by the processor 714, the computer program may cause the processor 714 to perform and/or be a means for performing the functions required for carrying out the process described with regard to the flowcharts of FIGS. 5 and 6 (discussed above).

FIG. 8 is a block diagram of an example of a network architecture 899 in which client systems 810, 820, and 830 and servers 840 and 845 may be coupled to a network 850. Client systems 810, 820, and 830 generally represent any type or form of computing device or system, such as devices 106 and 108 of FIG. 1.

Similarly, servers 840 and 845 generally represent computing devices or systems, such as application servers or database servers, configured to provide various database services and/or run certain software applications (e.g., functionality of data repository 120 of FIG. 1). Network 850 generally represents any telecommunication or computer network including, for example, an intranet, a wide area network (WAN), a local area network (LAN), a personal area network (PAN), or the Internet.

With reference to computing system 899 of FIG. 8, a communication interface, such as communication interface 722, may be used to provide connectivity between each client system 810, 820, and 830 and network 850. Client systems 810, 820, and 830 may be able to access information on server 840 or 845 using, for example, a Web browser, thin client application, or other client software. Such software may allow client systems 810, 820, and 830 to access data hosted by server 840, server 845, or storage devices 870(1)-(N). Although FIG. 8 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 840, server 845, storage devices 870(1)-(N), or any combination thereof. All or a portion of one or more of the example embodiments disclosed herein may also be encoded as a computer program, stored in server 840, run by server 845, and distributed to client systems 810, 820, and 830 over network 850.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for receiving real-time reviews about locations via a social network comprising:
transmitting, from a first client device, a request to a system for one or more reviews associated with a location;
providing, by the system, at least a portion of the request to a set of client devices;
receiving, by the system, a real-time review associated with the location from a second client device in response to the request, wherein:
the review includes temporally relevant information about the location,
the second client device is included in the set of client devices, and
the review was drafted at the second client device;
receiving, at the first client device, the review associated with the location;
displaying, by the first client device, a map comprising a symbol representing the review associated with the location;
receiving input at the first client device selecting the symbol representing the review; and
displaying at least a portion of the review in response to the received input, wherein the displayed at least a portion of the review is displayed based on a size of the display.

2. The method of claim 1, wherein the symbol representing the review is an emoji bubble.

3. The method of claim 2, wherein the displayed at least a portion of the review includes an image.

4. The method of claim 1, wherein the system determines that the second client device was at the location during a particular time period.

5. The method of claim 1, wherein at least one attribute of the symbol representing the received review is based on a selection made at the second client device.

6. The method of claim 1, further comprising:
receiving, by the system, additional reviews associated with the location in response to the request;
assigning, by the system, relevance numbers corresponding to the review and the additional reviews based at least in part on a number of upvotes or downvotes for each review; and
wherein the displayed review is displayed based on a larger value of the corresponding relevance number in comparison to the other relevance numbers.

7. The method of claim 1, wherein the displayed review is displayed based on a corresponding relevance number with a higher value than other reviews' relevance numbers, wherein the relevance number is based at least in part on how recently the review was created.

8. The method of claim 1, wherein the location associated with the review is based on a distance between the location and the first client device.

9. The method of claim 1, wherein the location associated with the review is depicted on the map by a heatmap, wherein locations with reviews that have been upvoted are represented on a the heatmap by a first color and locations with reviews that have been downvoted are represented on the heatmap by a second color.

10. A system for receiving real-time reviews about locations via a social network comprising:
a computer processor;
a memory; and
a review engine executing on the computer processor and configured to:
transmit, from a first client device, a request to a system for one or more reviews associated with a location;
provide, by the system, at least a portion of the request to a set of client devices;
receive, by the system, a real-time review associated with the location from a second client device in response to the request, wherein:
the review includes temporally relevant information about the location,
the second client device is included in the set of client devices, and
the review was drafted at the second client device;
receive, at the first client device, the review associated with the location;
display, by the first client device, a map comprising a symbol representing the review associated with the location;
receive input at the first client device selecting the symbol representing the review; and
display at least a portion of the review in response to the received input, wherein the displayed at least a portion of the review is displayed based on a size of the display.

11. The system of claim 10, wherein the symbol representing the review is an emoji bubble.

12. The system of claim 11, wherein the displayed at least a portion of the review includes an image.

13. The system of claim 10, wherein the review engine determines that the second client device was at the location during a particular time period.

14. The system of claim 10, wherein at least one attribute of the symbol representing the received review is based on a selection made at the second client device.

15. The system of claim 10, wherein the review engine is further configured to:
receive, by the system, additional reviews associated with the location in response to the request;
assign, by the system, relevance numbers corresponding to the review and the additional reviews based at least in part on a number of upvotes or downvotes for each review; and
wherein the displayed review is displayed based on a larger value of the corresponding relevance number in comparison to the other relevance numbers.

16. The system of claim 10, wherein the displayed review is displayed based on a corresponding relevance number with a higher value than other reviews' relevance numbers, wherein the relevance number is based at least in part on how recently the review was created.

17. The system of claim 10, wherein the location associated with the review is depicted on the map by a heatmap, wherein locations with reviews that have been upvoted are represented on a the heatmap by a first color, and locations with reviews that have been downvoted are represented on the heatmap by a second color.

18. A non-transitory computer-readable storage medium comprising a plurality of instructions for receiving real-time reviews about locations via a social network, the instructions configured to execute on at least one computer processor to enable the computer processor to:
transmit, from a first client device, a request to a system for one or more reviews associated with a location;
provide, by the system, at least a portion of the request to a set of client devices;
receive, by the system, a real-time review associated with the location from a second client device in response to the request, wherein:
the review includes temporally relevant information about the location,
the second client device is included in the set of client devices, and
the review was drafted at the second client device;
receive, at the first client device, the review associated with the location;
display, by the first client device, a map comprising a symbol representing the review associated with the location;
receive input at the first client device selecting the symbol representing the review; and
display at least a portion of the review in response to the received input, wherein the displayed at least a portion of the review is displayed based on a size of the display.

19. The non-transitory computer-readable storage medium of claim 18, wherein the location associated with the review is based on a distance between the location and the first client device.

20. The non-transitory computer-readable storage medium of claim 19, wherein the location associated with the review is depicted on the map by a heatmap, wherein locations with reviews that have been upvoted are represented on a the heatmap by a first color and locations with reviews that have been downvoted are represented on the heatmap by a second color.
